(19) United States
(12) Patent Application Publication
(10) Pub. No.: US 2006/0103522 A1
(43) Pub. Date: May 18, 2006

(54) Baby monitor with multi-sensory notification

(76) Inventor: Cathryn N. Spencer, Mansfield, TX (US)

Correspondence Address: LAW OFFICE OF STEVEN B. LEAVITT, 9914 WATERVIEW PARKWAY, ROWLETT, TX, 75089, US

(21) Appl. No.: 10/988,444

(22) Filed: Nov. 15, 2004

(51) Int. Cl. G08B 1/08

(52) U.S. Cl. 340/539.15

(57) ABSTRACT

A baby monitor for monitoring sounds wherein the monitor comprises a first base and a second base each having a microphone for detecting sound and a radio component for broadcasting the detected sound as a unique radio signal unique to each base. The baby monitor also has a receiver which contains a speaker for broadcasting a reproduction of the detected sound, a first indicator light to indicate if the unique radio signal is a first unique radio signal, a second indicator light to indicate if the unique radio signal is a second unique radio signal, and a vibrating motor which issues a first vibratory alert when a first unique radio signal is received and a second vibratory alert when a second unique radio signal is received.

### BACKGROUND OF THE INVENTION

1. Technical Field

The present invention relates to the field of monitoring devices, and more particularly, to a baby monitor for use in combination with at least two bases used to monitor the sounds made by a baby where a receiver produces a visual, audio, vibratory, or combinations thereof alert when a signal is received from one of the bases.

2. Description of Related Art

It is important for a care giver to monitor their charges such as infants, children, babies, incapacitated persons, etc. as closely as possible. Although it would be ideal to monitor a subject constantly, it is difficult to accomplish such intensive monitoring without the assistance of specialized monitoring equipment such as a baby monitor.

A standard baby monitor consists of a base and a receiver, each of which can be powered by a battery or an A/C current source, usually with an inline transformer, and is basically a combination microphone and radio transmitter/receiver. The base contains a microphone or other sound detecting device and is placed in a location near an infant or baby. The receiver contains a speaker and is placed in a location near a care giver. The base receives a sound such as a stirring or crying baby, converts it to an electrical signal, then to a radio signal and broadcasts the radio signal on a specific frequency to the receiver. The receiver receives the radio signal from the base, converts it to an electrical signal and sends that signal to a speaker, where it is converted into a sound for the care giver to hear and respond accordingly.

By feeding an electrical signal to the radio components of the base, radio waves are produced. The electrons made by the electrical signals in the metal atoms of an antenna change energy levels and emit radio waves. The bases broadcasts radio waves that are modulated which means the original sound signal is superimposed on the radio wave so that the radio wave “carries” the sound.

The receiver is basically a transmitter in reverse. The antenna is struck by the radio waves connected to the receiver. The radio waves affect the metal atoms, producing weak electric carrier signals in the antenna. The radio components extract the sound signal from the carrier signal, and this signal goes to an amplifier and speaker to reproduce the sound.

Like all waves, radio waves have a particular wavelength or frequency. The 43-50 MHz band is common in early cordless telephones and less expensive baby monitors. Because of the low frequency, these baby monitors have short ranges (about 1,000 ft/330 m) and poorer sound quality due to interference from structures and appliances. The 43-50 MHz phone signals can also be picked up easily on radio scanners, early cordless telephones, and similar nearby baby monitors.

The 900 MHz band (actually 900-928 MHz) is a common frequency for cordless phones and mid-ranged baby monitors. The higher frequency gives the baby monitor a greater range (5,000 to 7,000 ft/1,500 to 2,100 m) and better sound quality. However, 900 MHz signals can be picked up easily by most commercially available radio scanners.

In 1998, the FCC opened up the 2.4 GHz range for cordless phone and baby monitor use. A 2.4 GHz or 5.8 GHz baby monitor can operate over a greater distance and is above the frequencies that can be picked up by most commercially available radio scanners; therefore, it is more secure than lower frequency models.

Each frequency band (43-50 MHz, 900 MHz, 2.4 GHz or 5.8 GHz) can be subdivided into different increments or channels. For example, on some baby monitor models, the base searches for a pair of frequencies (channels) within a range, that is not already in use, to transmit to the receiver. If the base is capable of searching more increments, it can more easily find a frequency pair that is clear from interference, providing better sound quality. The number of baby monitor channels can vary as follows: 10 to 25 channels—43-50 MHz phones and some inexpensive 900 MHz phones; 20 to 60 channels—most 900 MHz phones; 50 to 100 channels—high-end 900 MHz and 2.4/5.8 GHz phones.

Most baby monitors include a plurality of light emitting diodes (LEDs), which light in series to indicate the level of the sound received by the receiver. This acts as a visual alert for the care giver in that as the sound level increases the number of LEDs that light also increases. As an added alert the color of the subsequently lit or higher sound-level LEDs is a different color from the lower sound-level LEDs (usually red and green, respectively). This visual alert is useful in an environment where there are other noises that may cause the receiver output to go unheard by the care giver. These other noises can be the sound from a television, radio, stereo, or other electronic device. These external noises can also be from noise-making electric appliances, for example, an electric mixer, a blender, a washing machine, or the like. However, often it is difficult to constantly watch the baby monitor to see the visual alert.

If the external noises are greater then the output of the baby monitor receiver, the sounds of the baby can go unheard by the care giver. Also, a problem with the LED model in particular arises when external noises are present and the receiver is out of the line-of-sight of the care giver. In this case, along with the sound going unheard, the visual alert goes unseen. Thus, in either case the baby could be crying and the care giver would be unaware of this potentially dangerous situation. Therefore, some baby monitors, such as the Fisher-Price® 900 MHz Long-Range Monitor Model B1474 have a vibrating alert.

The base of a baby monitor is not easily transported from room to room. If an infant or baby is going to be moved to a different room, then the base must also be moved to that room. It is difficult for busy care givers to remember to move the base each time the baby is moved. Also, some care givers have more than one child and unless each child is in the same room, then more than one baby monitor system is required to monitor the infant or baby. When more than one baby monitor system is used, the care giver is require to have a receiver for each base used, and it is difficult to keep up with multiple monitors.

Therefore, what is needed is a receiver that can receive the signal from more than one base. Because care givers must shower or be near water, it would also be a benefit if the receiver had a waterproof housing to allow the care giver to shower or be near water without having to forego use of the baby monitor. Also, it would be beneficial if the receiver would give multiple alert signals such as visual, audio, and vibratory.

### SUMMARY OF THE INVENTION

The present invention is a baby monitor which has two or more bases and a receiver capable of detecting the unique radio signal sent from each base. The receiver is small in size and has a water proof housing to allow the care giver to shower or be near water without having to forego use of the baby monitor. The receiver provides at least three alert signals: visual, audio, and vibratory. Preferably the visual and vibratory signals are unique to the base that sent the radio signal.

In use, when one base detects a sound, the base sends out a radio signal on a frequency unique to the base. The receiver receives the radio signal and uses the unique frequency to determine what base the radio signal came from. Once the receiver determines what base the radio signal came from, the speaker reproduces the detected sound and the receiver activates a visual and vibratory alert unique to the base. The care giver can hear the sound, see the unique visual alert and/or feel the unique vibratory alert and is able to determine what base detected the sound and thereby can respond accordingly.

Because the receiver can detect the signal from multiple bases, the care giver does not have to move a base each time the infant or baby changes rooms. Also, the care giver does not have to carry around multiple receivers to monitor multiple bases.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a plan view of a monitor system in accordance with the present invention;

FIG. 2 is a block diagram of an interior of a base of the present invention;

FIG. 3 is a block diagram of an interior of a receiver of the present invention;

FIG. 4 is a plan view of a receiver in use with a recharging station of the present invention; and

FIG. 5 is a plan view of a receiver in use with a movement monitor of the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

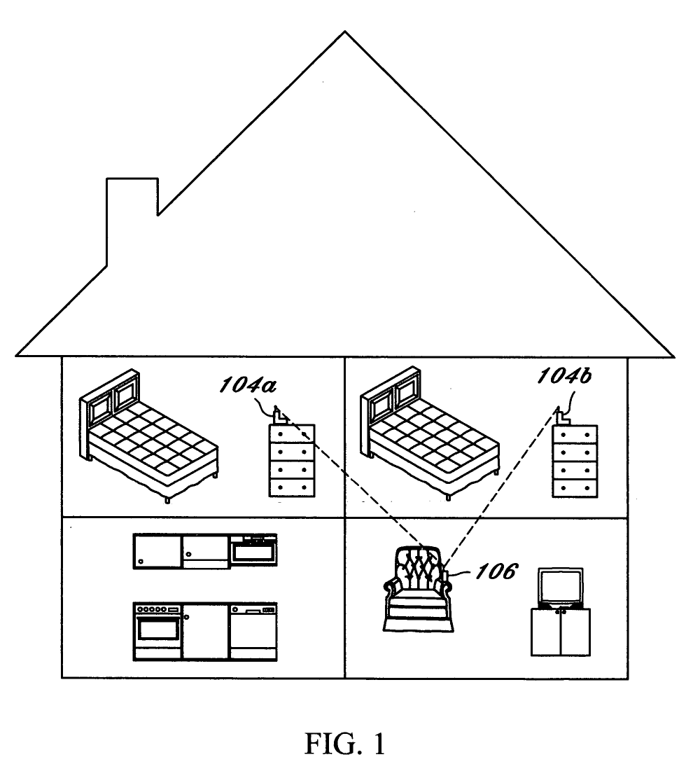

As shown in FIG. 1, the baby monitor includes bases 104a and 104b and one receiver 106. More bases and more receivers could be used and such use will be described in detail further below. Bases 104a and 104b are typical bases found with most baby monitors known in the art and each one is able to transmit on its own unique fixed frequency. The unique frequency can be any frequency allowed by the FCC but is preferably the highest frequency allowed such as 2.4 GHz or 5.8 GHz.

The 2.4 GHz or 5.8 GHz frequency allows increased distance over which the monitor can operate and is out of the frequency range of most radio scanners, thereby providing increased security from radio scanners. For additional security, the baby monitor uses a digital spread spectrum (DSS) as is known in the art. DDS enables the signal sent from bases 104a and 104b to receiver 106 to be spread in “pieces” over several frequencies, thereby deterring or more preferably making it almost impossible to eavesdrop on the baby monitor.

Receiver 106 is able to receive the unique frequency sent from base 104a and the unique frequency sent from base 104b. For example, if base 104a transmits at 901 MHz and base 104b transmits at 902 MHz, receiver 106 can receive both signals.

Receiver 106 contains indicator lights 208a and 208b. Indicator lights 208a and 208b may be liquid crystal displays (LCDs), light-emitting diodes (LEDs), or some other similar type indicator light. Indicator light 208a produces a first unique visible indicator when base 104a transmits a signal. Indicator light 208b produces a second unique visible indicator when base 104b transmits a signal.

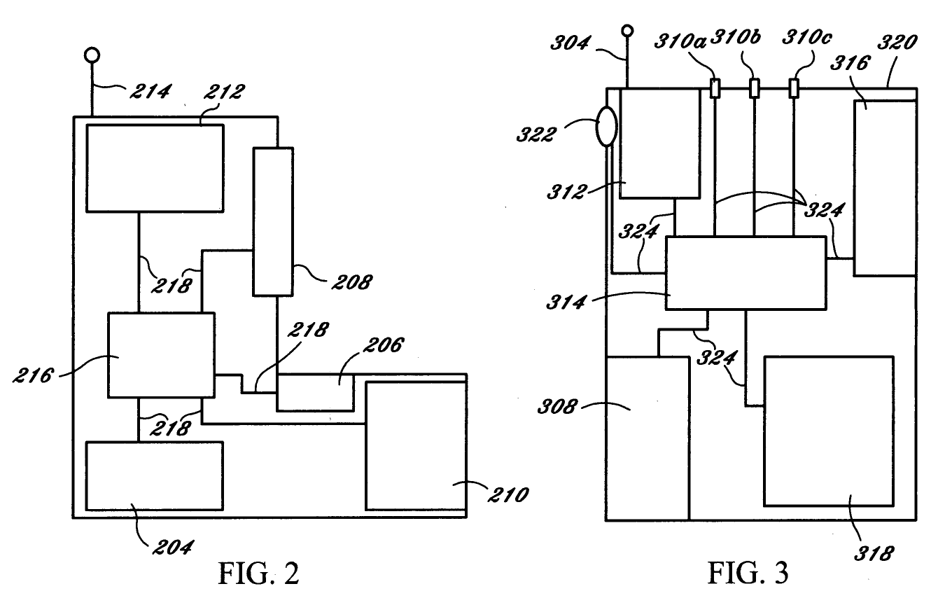

As shown in FIG. 2, base 104a includes power components 204, battery charger 206, indicator lights 208, microphone 210, radio components 212, base antenna 214, processor 216, and electrical wire 218. For clarity and conciseness, a detailed description of base 104b is omitted. Base 104b is the same as base 104a except base 104b is in a different location than 104a and transmits on a different frequency.

Power components 204 supply low voltage power to the circuits and recharges the battery of the receiver 106. A typical DC power cube transformer as known in the art supplies the low voltage required by the electrical components of base 104a. The power components on the processor 216 work with the power cube to supply electrical current to re-charge the battery of the receiver 106. Power components 204 supply power to all the necessary components of base 104a via electrical wires 218.

Battery charger 206 is compatible with the rechargeable battery 308 in the receiver 106. Battery 308 may be a AAA or AA Nickel-cadmium battery, Nickel-metal hydride battery, Lithium-ion battery, Zinc-air battery, or any other rechargeable battery known in the art. Battery charger 206 recharges the battery 308 as is known in the art.

Processor 216 is suitable for enabling all electronics and electrical function of the baby monitor and is a typical commercially available processor well known in the art, examples include processors from Atmel, Inc. located at 2325 Orchard Parkway, San Jose, Calif. 95131 USA or ZiLOG, Inc. located at 532 Race Street San Jose, Calif. 95126. Further description of the electronics and processor 216 hardware and software for operating base 104a as a base for a baby monitor is not necessary for one of ordinary skill in the art to make and use the inventions disclosed herein.

Indicator lights 208 may be liquid crystal displays (LCDs), light-emitting diodes (LEDs), or some other similar type indicator light. Indicator lights 208 indicate whether or not base 104a is receiving power and if the receiver 106 is charging.

Microphone 210 electronically receives varying pressure waves in the air caused by sound in the vicinity of base 104a and converts them into varying electrical signals. Microphone 210 is preferably an omnidirectional microphone that picks up sound from all directions and has a diaphragm that is vibrated by sound waves in the vicinity of base 104a. The sound waves make tiny electric currents either by moving a coil of wire within a magnet or by compressing the membrane against carbon dust.

Microphone 210 is a typical commercially available microphone, and may be a carbon microphone, dynamic microphone, ribbon microphone, condenser microphone, crystal microphone or any other microphone known in the art such as the Panasonic WM-64PCTM omnidirectional miniature electret microphone available from Panasonic Matsushita Electric Corporation of America located at One Panasonic Way, Secaucus, N.J. 07094 or the Horn Electret Condenser Microphone available from Mouser Electronics, Inc. located at 1000 North Main Street Mansfield, Tex. 76063. The electrical signals from microphone 210 are sent to the audio amplifier in radio components 212 via electrical connection 218.

Radio components 212 amplify the electrical signals from microphone 210 and convert them to radio waves. The radio waves are then broadcast to the receiver 106 via base antenna 214. Radio components 212 may use quartz crystals to set the radio frequencies for sending and receiving signals.

In a second embodiment, base 104a uses filtration electronics to determine the best frequency to send the signal. Such use of filtration electronics is known in the art. After the radio waves are broadcast from base 104a via base antenna 214, the radio waves are detected by receiver antenna 304 on receiver 106 shown in FIG. 3.

Receiver 106 contains receiver antenna 304, battery 308, indicator lights 310a, 310b, and 310c, radio components 312, processor 314, speaker 316, vibrating motor 318 and volume control knob 322. All electric components are operationally connected together by electrical wires 324. Casing 320 surrounding receiver 106 is a waterproof casing.

The receiver 106 may be battery powered or have a connection for plugging into an electrical wall outlet or both. A typical DC power cube transformer as known in the art supplies the low voltage required by the electrical components via electrical wires 324.

Battery 308 can be a AAA, AA, or any other sized battery and may be a nickel-cadmium, Nickel-metal hydride, Lithium-ion, Zinc-air, or any other similar battery known in the art for use in small personal electronics. Preferably, battery 308 is a rechargeable battery such as the Nickel Metal Hydride (NiMH) AAA rechargeable battery available from Rayovac Corporation located at Six Concourse Parkway, Suite 3300, Atlanta, Ga. 30328 or the NIMH AAA rechargeable battery available from NEXcell® Battery Co., Ltd. located at 1251 Shamrock Avenue, Monrovia Calif. 91016. Battery 308 supplies the power for all of the electrical components in the receiver 106. When the battery runs low, indicator light 310c begins to dim or flash. If a rechargeable battery is low, it can be recharged on the base 104a or 104b. When receiver 106 is on a base recharging, receiver 106 can receive signals from another base. However, to avoid feedback problems, receiver 106 cannot receive signals from the base it is recharging in. For example, if receiver 106 is recharging in base 104a, then receiver 106 can receive signals from base 104b but cannot receive signals from base 104a.

Antenna 304 is made from a coil of wire wrapped around a metal core and can receive the radio signal from the base 104a and 104b. The received radio signal is sent to radio components 312 where is it converted into an electrical signal and sent to processor 314.

Processor 314 is suitable for enabling all electronics and electrical function of receiver 106 and is a typical commercially available processor well known in the art, examples include processors from Atmel, Inc. located at 2325 Orchard Parkway, San Jose, Calif. 95131 USA or ZiLOG, Inc. located at 532 Race Street, San Jose, Calif. 95126. Further description of the electronics and processor 314 hardware and software for receiver 106 as a receiver for a baby monitor is not necessary for one of ordinary skill in the art to make and use the inventions disclosed herein.

Processor 314 determines what base the signal came from and sends an alert using one or more of three methods: audio, visual or vibratory. If the signal came from base 104a, then a signal is sent from processor 314 to indicator light 310a causing indicator light 310a to glow resulting in a visual alert, to speaker 316 causing the speaker to recreate the sound detected in the vicinity of base 104a, and to vibrating motor 318 causing a unique vibratory alert. If the signal came from base 104b, then a signal is sent from processor 314 to indicator light 310b causing indicator light 310b to glow resulting in a visual alert, to speaker 316 causing the speaker to recreate the sound detected in the vicinity of base 104b, and to vibrating motor 318 causing a unique vibratory alert different from the one used when the signal came from base 104a.

Indicator lights 310a and 310b may be liquid crystal displays (LCDs), light-emitting diodes (LEDs) or some other similar type indicator light. Indicator light 310a emits a different color than indicator light 310b which gives a unique visual signal for each indicator light.

Because base 104a and 104b broadcasts radio waves that are modulated, meaning the original sound signal is superimposed on the signal, receiver 106 is able to detect the volume of the original sound. When the volume of the sound is relatively low, processor 314 sends a relatively low voltage signal to indicator light 310a or 310b, speaker 316, and vibrating motor 318. The relatively low voltage signal causes indicator light 310a or 310b to emit a relatively dim glow, speaker 316 to produce a relatively low volume sound, and vibrating motor 318 to vibrate at a relatively low intensity.

When the volume of the sound is relatively high, processor 314 sends a relatively high voltage signal to indicator light 310a or 310b, speaker 316, and vibrating motor 318. The relatively high voltage signal causes indicator light 310a or 310b to emit a relatively bright glow, speaker 316 to produce a relatively high volume sound, and vibrating motor 318 to vibrate at a relatively high intensity.

Therefore, intensity of the visual, audio, and vibratory alert increase as the volume of the sound detected by base 104a or 104b increases. As is known in the art, the sound reproduced on speaker 316 will have relatively the same volume as the sound detected by base 104a or 104b. The volume of the sound reproduced by the speaker is also controlled through volume control knob 322.

Speaker 316 is a commercially available speaker known in the art such as the 8 ohm, 0.1 watt speaker catalog number SK-218 available from All Electronics Corp. located at 14928 Oxnard St. Van Nuys, Calif. or Kobitone Speaker SPKR 8 OHM 1 W 16×35 MM. Speaker 316 receives the electrical signals from the processor 314 via electrical wire 324 and converts the electrical signal into sound.

The electrical signals from processor 314 travel to a coil of copper wire and induce magnetic currents in the coil of wire, thereby making it an electromagnet. The electromagnetic coil moves in and out of grooves within a permanent magnet. This moves an attached plastic membrane in and out at the same frequencies as the changes in electric currents. The movements of the membrane move air at the same frequencies, thereby creating sound waves that can be heard and reproduce the sound detected by base 104a.

Vibrating motor 318 contains a small DC motor that drives a gear attached to the motor's spindle which is connected to a small weight. The weight is mounted off-center on the motor's spindle and when the motor spins the weight. The off-center mounting causes a strong vibration.

Vibrating motor 318 is a typical vibrating motor commercially available and known in the art such as the dual, monostable multivibrator, catalog number MC 14528 available from All Electronics Corp. located at 14928 Oxnard St., Van Nuys, Calif. 91411 or the Fairchild VHC/VHCT CMOS Logic SOIC-16 Dual Multivibrator available from the FairChild Corporation located at 1750 Tyson's Blvd Suite 1400, McLean, Va. 22102. Vibrating motor 318 can vibrate at different speeds such as fast or slow or any combination of fast then slow or slow then fast. Because vibrating motor 318 can vibrate at different speeds, a unique vibratory alert can be used for the bases 104a and 104b.

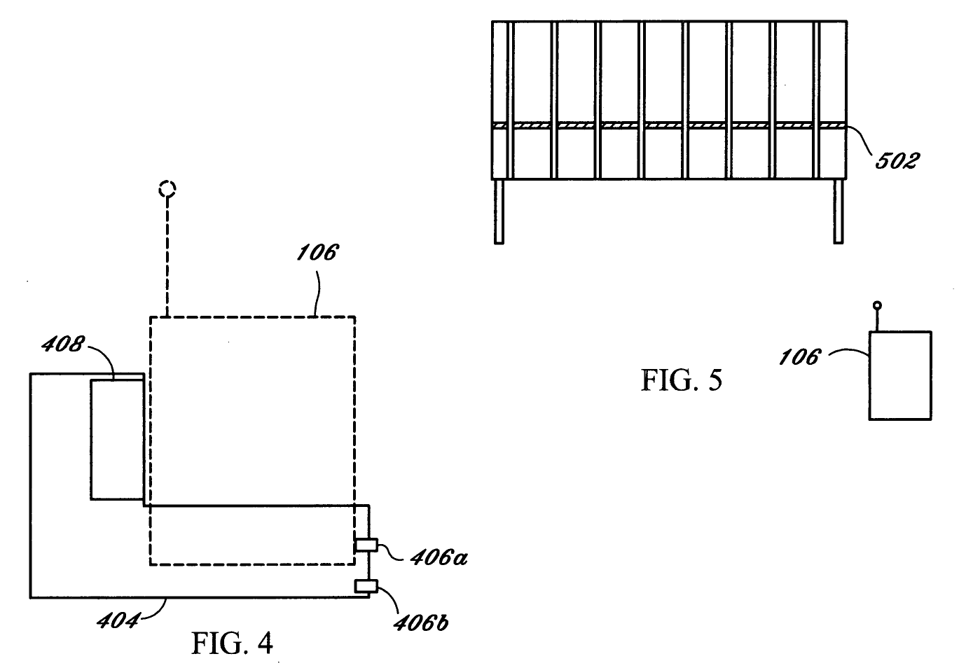

In another embodiment, shown in FIG. 4, receiver 106 may be recharged in a recharging station 404. Recharging station 404 may be battery powered or have a connection for plugging into an electrical wall outlet or both. Recharging station 404 contains indicator lights 406a and 406b and speaker 408.

When receiver 106 is placed in recharging station 404, the processor 314 detects recharging station 404 and instead of sending alert signals to indicator light 310a and 310b and speaker 316 the signals are sent to indicator lights 406a and 406b and speaker 408. No vibratory signal is given. Indicator lights 406a and 406b are similar to and operate in the same manner as indicator lights 310a and 310b respectively. Speaker is similar to and operates in the same manner as speaker 316. When receiver 106 is in recharging station 404, no signal is sent to vibrating motor 318.

In another embodiment, shown in FIG. 5, receiver 106 is configured to receive signals from movement monitor 502 as is known in the art. Such movement monitors operate in a similar function to the base 104a and emit a radio signal at a unique predetermined frequency. Receiver 106 is tuned to receive the unique frequency sent by movement monitor 502 and give the appropriate alert based on the unique frequency.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

What is claimed is:

1. A baby monitor for monitoring sounds, the monitor comprising:
a first base comprising:
a microphone for detecting sound; and
a radio component for broadcasting the detected sound as a first unique radio wave;
a second base comprising:
a microphone for detecting sound; and
a radio component for broadcasting the detected sound as a second unique radio wave; and
a receiver comprising:
a radio component for detecting the first and second unique radio wave;
a speaker for broadcasting a reproduction of the detected sound;
a first indicator light to indicate if the unique radio wave is a first unique radio wave; and
a second indicator light to indicate if the unique radio wave is a second unique radio wave.

2. The baby monitor of claim 1 further comprising a vibratory alert that is activated when a unique radio wave is detected.

3. The baby monitor of claim 2 wherein the vibratory alert is a first vibratory alert to indicate if the unique radio wave is the first unique radio wave.

4. The baby monitor of claim 2 wherein the vibratory alert is a second vibratory alert to indicate if the unique radio wave is the second unique radio wave.

5. The baby monitor of claim 2 wherein the intensity of the vibratory alert increases as the volume of the detected sound increases.

6. The baby monitor of claim 1 wherein the intensity of the indicator light increases as the volume of the detected sound increases

7. The baby monitor of claim 1 wherein the receiver is waterproof.

8. The baby monitor of claim 1 further comprising a recharging station.

9. The baby monitor of claim 8 wherein the recharging station further comprises:
a speaker for broadcasting a reproduction of the detected sound;
a first indicator light to indicate if the unique radio wave is the first unique radio wave; and
a second indicator light to indicate if the unique radio wave is the second unique radio wave.

10. The baby monitor of claim 1 further comprising:
a third base comprising:
a movement monitor for detecting a baby's movement; and
a radio component for broadcasting a third unique radio wave; and
wherein the receiver further comprises a third indicator light to indicate if the third unique radio wave is detected.

11. A baby monitor for monitoring sounds, the monitor comprising:
a first base comprising:
means for detecting sound; and
means for broadcasting the detected sound as a first unique signal;
a second base comprising:
means for detecting sound; and
means for broadcasting the detected sound as a second unique signal; and
a receiver comprising:
means for detecting the first and second unique signal;
means for broadcasting a reproduction of the detected sound;
means to indicate if the unique signal is the first unique signal; and
means to indicate if the unique signal is the second unique signal.

12. The baby monitor of claim 11 further comprising a vibratory alert that is activated when a unique signal is detected.

13. The baby monitor of claim 12 wherein the vibratory alert is a first vibratory alert to indicate if the unique signal is the first unique signal.

14. The baby monitor of claim 12 wherein the vibratory alert is a second vibratory alert to indicate if the unique signal is the second unique signal.

15. The baby monitor of claim 12 wherein the intensity of the vibratory alert increases as the volume of the detected sound increases.

16. The baby monitor of claim 11 wherein the receiver is waterproof.

17. The baby monitor of claim 11 further comprising a recharging station.

18. A method for using a baby monitor having multiple bases and one receiver, wherein the method comprises the steps of:
positioning a first base to detect sound wherein the first base comprises:
a microphone for detecting sound; and
a radio component for broadcasting the detected sound as a first unique radio wave;
positioning a second base to detect sound wherein the first base comprises:
a microphone for detecting sound; and
a radio component for broadcasting the detected sound as a second unique radio wave; and
detecting the first unique radio wave and second unique radio wave using a receiver comprising:
a radio component for detecting the first and second unique radio wave;
a speaker for broadcasting a reproduction of the detected sound;
a first indicator light to indicate if the unique radio wave is the first unique radio wave; and
a second indicator light to indicate if the unique radio wave is the second unique radio wave.

19. The method of claim 18 further comprising issuing a vibratory alert when a unique signal is detected.

20. The method of claim 19 wherein the intensity of the vibratory alert increases as the volume of the detected sound increases.
